(19) United States
(12) Patent Application Publication
(10) Pub. No.: US 2006/0053956 A1
(43) Pub. Date: Mar. 16, 2006

(54) Steering wheel with decorative element

(75) Inventor: Martin Kreuzer, Kleinwallstadt (DE)

Correspondence Address: TAROLLI, SUNDHEIM, COVELL, & TUMMINO L.L.P., 1111 LEADER BLDG., 526 SUPERIOR AVENUE, CLEVELAND, OH, 44114-1400, US

(73) Assignee: TRW Automotive Safety Systems GmbH

(21) Appl. No.: 11/185,549

(22) Filed: Jul. 20, 2005

(30) Foreign Application Priority Data
Aug. 5, 2004 (DE) 20 2004 012 304.5

(51) Int. Cl. B62D 1/04

(52) U.S. Cl. 74/552

(57) ABSTRACT

A steering wheel (10) includes a steering wheel rim (14), a hub and at least one spoke (16) connecting the steering wheel rim (14) and the hub. The steering wheel rim (14) and/or the spoke (16) has/have a skeleton (20) and a surrounding foam (22) or an injected material surrounding the skeleton (20). The steering wheel (10) further comprises at least one decorative element (18) having at least one detent element (44) for fastening the decorative element (18). The detent element (44) engages into a holding piece (30) which is fastened to the skeleton (20) and preferably environed by the foam (22) or by the injected material, respectively.

### TECHNICAL FIELD

The invention relates to a steering wheel comprising a steering wheel rim, a hub and at least one spoke connecting the steering wheel rim and the hub.

### BACKGROUND OF THE INVENTION

In order to give steering wheels a high-class appearance, it is known to arrange decorative elements on the steering wheel rim. Often, such decorative elements are combined with a leather covering of the steering wheel rim. From German Utility Model DE 200 13 706 U1 a steering wheel having a skeleton and a foam surrounding the skeleton is known. The steering wheel further comprises decorative elements with detent elements for fastening the decorative elements. The decorative elements are thus connected to a separately manufactured shell surrounding the foam.

It is an object of the invention to provide a steering wheel which can be produced at a favourable cost, with decorative elements which can be applied simply, the finishing effort being as little as possible.

### BRIEF SUMMARY OF THE INVENTION

A steering wheel according to the invention comprises a steering wheel rim, a hub and at least one spoke connecting the steering wheel rim and the hub; the steering wheel rim and/or the spoke has/have a skeleton and a surrounding foam or an injected material surrounding the skeleton; the steering wheel further comprises at least one decorative element having at least one detent element for fastening the decorative element; the detent element engages into a holding piece which is fastened to the skeleton. Preferably, the holding piece is environed by the foam or by the injected material, respectively. Before the skeleton is surrounded with foam, the holding piece is fastened thereto and thereby becomes a fixed component of the steering wheel rim or of the steering wheel spoke. The decorative element can then be clipped into the holding piece without a great effort. A connection of the decorative element with the skeleton or with a shell surrounding the foam is not provided for.

### BRIEF DESCRIPTION OF THE DRAWINGS

FIG. 1 shows a steering wheel according to the invention; and

FIG. 2 shows a section along the line I-I in FIG. 1.

### DETAILED DESCRIPTION OF THE PREFERRED EMBODIMENT

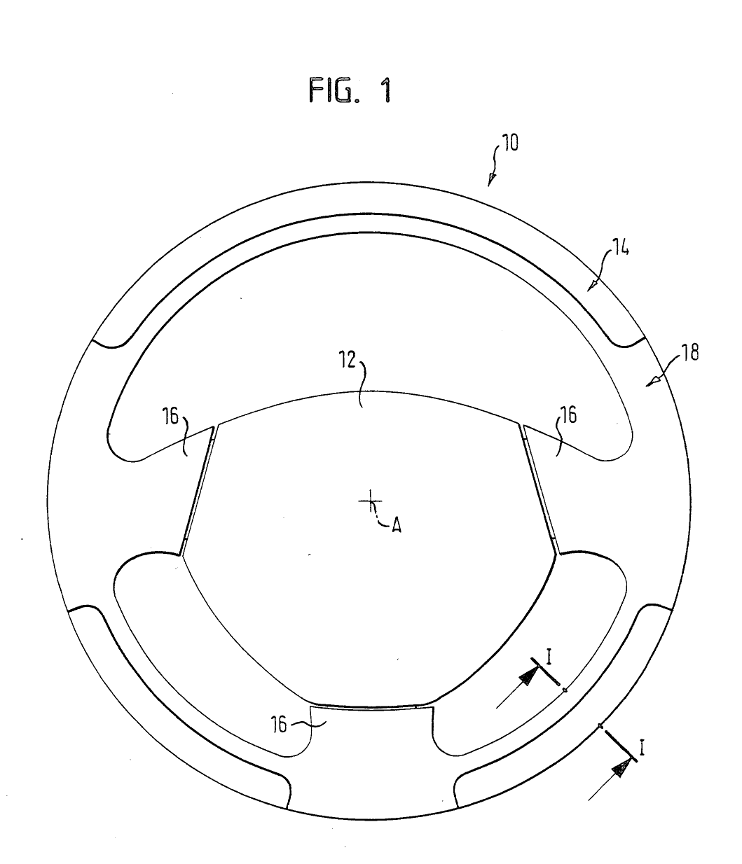

In FIG. 1 a steering wheel 10 according to the invention is depicted with a central axis A. The steering wheel 10 comprises a hub, which is covered by a covering 12 and a gas bag module lying therebeneath. The steering wheel 10 further comprises a steering wheel rim 14 and spokes 16 which connect the steering wheel rim 14 with the hub. On the steering wheel rim 14 a decorative element 18 is arranged. According to other example embodiments, several and/or differently arranged decorative elements 18 can be provided; e.g. the decorative elements 18 may also be arranged on the spokes 16.

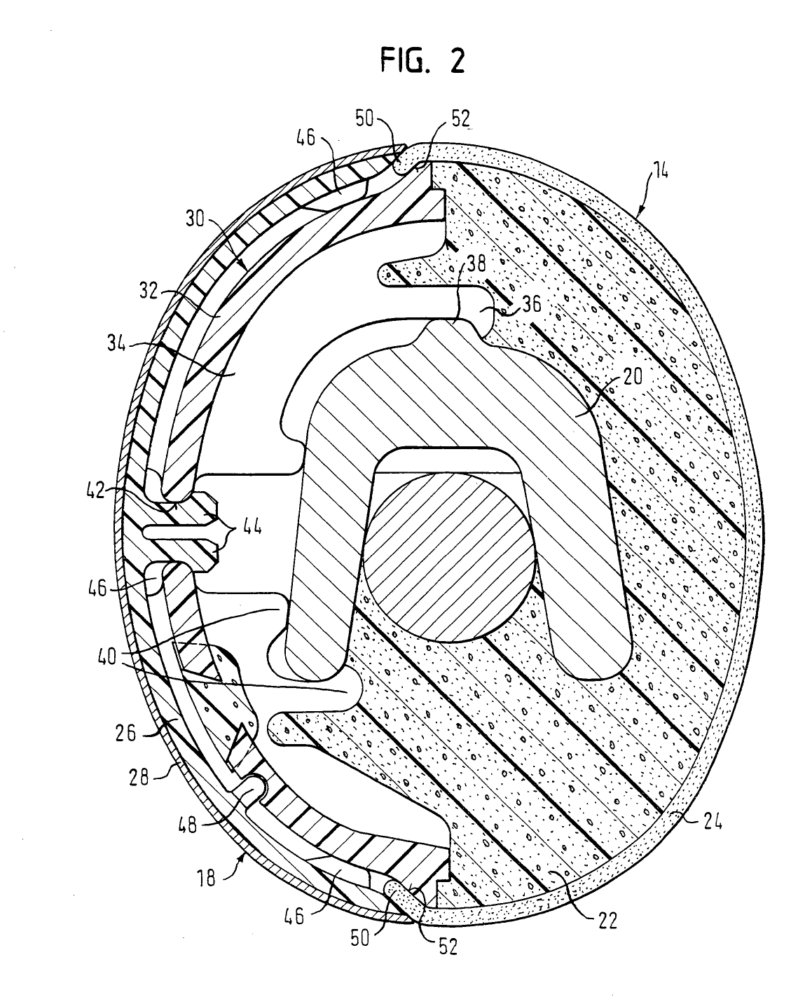

FIG. 2 shows a section through the steering wheel rim 14 along the line I-I and illustrates the construction of the steering wheel 10. The steering wheel rim 14 and the spokes 16 contain in their interior a skeleton 20 which gives the steering wheel 10 the basic stability. The skeleton 20 is surrounded by a foam 22 consisting, for example, of PUR and which can be applied onto the skeleton 20 in a known foaming process. The layer designated by the reference number 22 can, however, also consist of a thermoplast applied by injection molding or of an expandible PE or PP. As the outermost layer, the steering wheel rim 14 has a leather covering 24 which is supplemented by the decorative element 18. The decorative element 18 consists of a support part 26 of plastic and of a veneer wood 28 applied externally thereon.

A holding piece 30 of plastic, having an outer section 32 and an inner section 34, is inserted into the surrounding foam 22. A hook 36 of the holding piece 30 embraces a projection 38 formed on the skeleton 20. The holding piece 30 is positioned exactly, with respect to the skeleton 20, by positioning sections 40. The holding piece 30 has an opening 42 through which a detent element 44 of the decorative element 18 projects. The detent element 44, which is preferably constructed in one piece with the decorative element 18, has two flexible detent hooks which engage behind the outer section 32 of the holding piece 30. Depending on the dimensions of the decorative element 18, a suitable number of such detent connections is provided.

Between the outer section 32 of the holding piece 30 and the inner side of the decorative element 18, several spacers 46 are arranged. The spacers 46 establish the distance of the decorative element 18 from the holding piece 30 and thus provide for a visually flawless transition between the leather covering 24 and the decorative element 18. In addition, positioning pins 48 are provided on the decorative element, which engage into corresponding recesses of the holding piece 30, in order to prevent a torsion of the decorative element 18.

For the production of the steering wheel 10 according to the invention, the skeleton 20 is surrounded by foam or injection-molded around in a known manner. Previously, the holding piece 30 is clipped onto the skeleton 20 by the hooks 36 and is fixed by the positioning sections 40 automatically in precise position. The foaming mold is sealed over the holding piece 30. With respect to the central axis A of the steering wheel 10, either one completely encircling holding piece 30, or several holding pieces 30 spaced apart from each other can be provided. In the latter case, the holding pieces 30 are sealed at their distal ends by formed-on ribs (not shown) against a lateral inflow of foam. After the foaming process, the leather covering 24 is applied. Finally, the decorative element 18 is clipped onto the holding piece 30 by means of the detent elements 44. The edges 50 of the leather covering 24 are clamped between particular bearing surfaces 52 of the holding piece 30 and the decorative element 18. A finishing of the steering wheel 10 is not necessary.

1. A steering wheel, the steering wheel comprising a steering wheel rim, a hub and at least one spoke connecting the steering wheel rim and the hub, at least one of the steering wheel rim and the spoke having a skeleton, and one of a surrounding foam and an injected material surrounding the skeleton, the steering wheel further comprising at least one decorative element having at least one detent element for fastening the decorative element, the detent element engaging into a holding piece which is fastened to the skeleton.

2. The steering wheel according to claim 1, wherein the holding piece is environed by the foam or by the injected material, respectively.

3. The steering wheel according to claim 1, wherein the holding piece has at least one hook which engages on a projection of the skeleton.

4. The steering wheel according to claim 1, wherein the holding piece has positioning sections which establish the position of the holding piece relative to the skeleton.

5. The steering wheel according to claim 1, wherein a holding piece is provided, fully encircling with respect to the central axis A of the steering wheel.

6. The steering wheel according to claim 1, wherein several holding pieces are provided, spaced apart from each other.

7. The steering wheel according to claim 6, wherein on the end faces of the holding pieces ribs are formed, for sealing.

8. The steering wheel according to claim 1, wherein spacers are arranged between the decorative element and the holding piece.

9. The steering wheel according to claim 1, wherein the decorative element has at least one positioning element which engages into a corresponding mounting of the holding piece.

10. The steering wheel according to claim 1, wherein the holding piece is constructed in two parts.
